(19) United States
(12) Patent Application Publication
(10) Pub. No.: US 2012/0141358 A1
(43) Pub. Date: Jun. 7, 2012

(54) Method for Making Nanometer ITO Powder

(75) Inventors: Yen-Chung Chen, Taoyuan County (TW); Hsiou-Jeng Shy, Taipei County (TW); Hsin-Chun Lu, Taipei (TW); Ching-Hung Chiu, Taipei County (TW); Kai-Wei Wang, Taipei County (TW)

(73) Assignee: Chung-Shan Institute of Science and Technology, Armaments, Bureau, Ministry of National Defense, Taoyuan County (TW)

(21) Appl. No.: 12/957,621

(22) Filed: Dec. 1, 2010

(51) Int. Cl. C01G 19/02; B82Y 40/00

(52) U.S. Cl. 423/594.9; 977/896

(57) ABSTRACT

Disclosed is a method for making nanometer ITO powder. In the method, first and second reactants are added to a solvent to provide a clear metal ion solution. The solvent is an alcohol or an organic solvent. The clear metal ion solution is added to a hydrolysis concentration solution at a desired ratio to provide a first solution. The hydrolysis concentration solution contains a sour catalyst and water. An aging step is taken on the first solution and the hydrolysis concentration solution to provide a second solution. A solvothermal step is executed on the second solution to provide multi-ingredient transparent conductive ITO powder in the order of nanometer. The solvothermal step includes the steps of locating the second solution in a solvothermal device and heating the second solution to a solvothermal temperature for a solvothermal reaction.

### BACKGROUND OF INVENTION 1. Field of Invention

The present invention relates to a method for making transparent and conductive ITO powder with a desired concentration of tin by a solvothermal step instead of drying and sintering steps of a sol-gel method.

2. Conventional Methods

In a sol-gel method, two or more metal salts or metal mellow oxides are used as row materials and dissolved in alcohol or an organic solvent to provide an even solution. Then, a hydrolysis condensation agent is added to the solution. At a low temperature, hydrolysis condensation occurs to provide a stable clear solution of a precursor. The solution of the precursor is dried to provide xerogel of the precursor. Finally, the xerogel of the precursor is sintered to provide multi-ingredient oxide powder. Among wetting chemical methods, sol-gel methods are good methods for making even, pure powder with few defects. Sol-gel methods exhibit several advantages. At first, they produce even oxides for using reactants in the form of molecules. Secondly, they easily produce different shapes of products. Thirdly, they effectively control the sizes of holes. Fourthly, they require low temperatures. These advantages have been addressed in various papers.

When a sol-gel method is used to produce multi-ingredient transparent conductive metal oxide such ITO, AZO and ATO powder, in the drying and sintering steps, high temperatures excessive energy however vaporize a small amount of impurities and affects the concentration of the components of the final product. Alternatively, a slow heating process would cause particles to aggregate to become larger particles. Under these circumstances, neterogeny doped multi-ingredient transparent conductive oxide powder with a desired concentration of impurities cannot be made.

Sel-gel methods for making nanometer crystalline ITO powder have been disclosed in papers as follows:
1. Dabin Yu, Weichao Yu, Debao Wang, Yitai Qian, Thin Solid Films 419 (2002) 166-172;
2. D.Yu., Shu, -Hong Yu, Shuyuan, Zhang, Jian Zuo, Debao Wang, Yitai Qian, Adv. Funct. Mater. 13(2003)6;
3. [3] Min-Kyu Jeon, Misook Kang, Materials Letters 62 (2008) 676-682;
4. Dabin Yu, Debao Wang, and Yitai Qian, Journal of Solid State Chemistry 177 (2004) 1230-1234;
5. Jin-Seok Lee, Sung-Churl Choi, Journal of the European Ceramic Society 25 (2005) 3307-3314;
6. Jianrong Zhang, Lian Gao, Minghai Chen, Materials Letters 61 (2007) 2671-2674; and
7. Elin Hammarberg, Anna Prodi-Schwab, Claus Feldmann, Thin Solid Films 516 (2008) 7437-7442.

Some parameters of the above-mentioned papers are shown in a table as follows:

| Paper | Reactants | Status | Structure | Size | | Temperature | Solvent |
|---|---|---|---|---|---|---|---|
| 1 | Chlorinated salt | Settlement | InOOH | 18 | nm | 580° C. | EDA |
| 2 | Indium chloride | Settlement | InOOH | 80 | nm | 490° C. | Ether |
| 3 | Chlorinated salt | Settlement | InOOH | | | 600° C. | IPA |
| 4 | Indium chloride | Settlement | InOOH | 5-30 | nm | 490° C. | EDA |
| 5 | Indium nitrate | Settlement | c-In₂O₃ | 10-20 | nm | NA | EtOH/EG/PEG |
| 6 | Metal + nitric | Clear | InOOH | 15-20 | nm | 550° C. | IPA + ethylene |
| | acid | | | | | | acetone |
| 7 | Chlorinated salt | Settlement | c-In₂O₃ | 15-19 | nm | NA | DEG |

Only paper nos. 5 and 7 disclose methods for directly making nanometer crystalline ITO powder. The other papers disclose methods for making products with structures of InOOH that have to undergo subsequent heat treatment to become oxides. However, in paper nos. 5 and 7, settlement is used as a precursor and alkali chemicals must be used to adjust the pH value of the solution before the solvothermal step. Ammonia is used in the method disclosed in paper no. 5. Ammonia is not dangerous; however, it increases the cost. Tetramethyl ammonia hydroxide is used in the method disclosed in paper no. 7. Tetramethyl ammonia hydroxide is a strong alkali and imposes a potential danger for an operator.

The present invention is therefore intended to obviate or at least alleviate the problems encountered in the conventional methods.

### SUMMARY OF INVENTION

It is the primary objective of the present invention to improve a method for making transparent and conductive ITO powder with a desired concentration of tin by replacing the drying and sintering steps of a sol-gel method with a solvothermal step.

To achieve the foregoing objective, the method includes the step of adding first and second reactants to a solvent to provide a clear metal ion solution. The solvent is an alcohol or an organic solvent. The clear metal ion solution is added to a hydrolysis concentration solution at a desired ratio to provide a first solution. The hydrolysis concentration solution contains a sour catalyst and water. An aging step is taken on the first solution and the hydrolysis concentration solution to provide a second solution. A solvothermal step is executed on the second solution to provide multi-ingredient transparent conductive ITO powder in the order of nanometer. The solvothermal step includes the steps of locating the second solution in a solvothermal device and heating the second solution to a solvothermal temperature for a solvothermal reaction.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a flow chart of a method for making transparent and conductive ITO powder with a desired concentration of tin according to the preferred embodiment of the present invention;

FIG. 2 is an X-ray diffraction (“XRD”) photograph of the structure of the ITP powder made according to the method shown in FIG. 1; and

FIG. 3 is a transmission electron microscope (“TEM”) photograph of the structure of the ITP powder made according to the method shown in FIG. 1.

### DETAILED DESCRIPTION OF PREFERRED EMBODIMENT

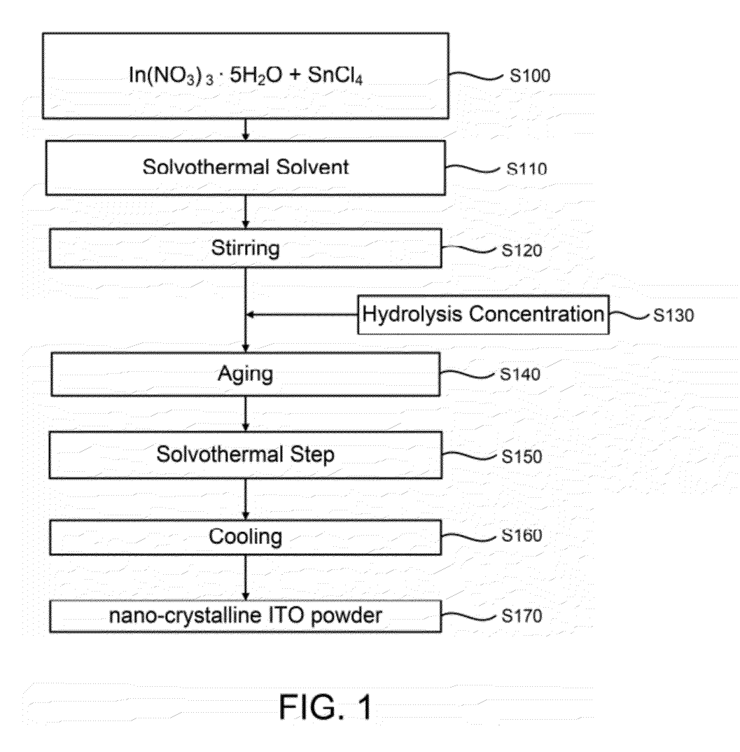

Referring to FIG. 1, at S100, first and second reactants are provided. The first reactant is indium nitrate for example while the second reactant is tin chloride for example. The first and second reactants are used to make transparent conductive indium tin oxide (“ITO”) powder with a desired ratio of certain components. For example, a weight ratio of In₂O₃:SnO₂ is preferably 90:10.

At S110, a solvent is provided. The solvent is an alcohol or an organic solvent. The alcohol is methanol, ethanol or isopropanol for example. The organic solvent is ethylene golycol or ethylene diamine for example. The first and second reactants are added to the alcohol or organic solvent.

At S120, the solution is stirred at a low temperature so that the first and second reactants are completely dissolved by the solvent and become a clear first solution.

At S130, the first solution added to a hydrolysis condensation solution containing a sour catalyst and water so that the first solution is hydrolyzed and condensed. The sour catalyst is HNO₃ for example.

At S140, the first solution and the hydrolysis condensation solution are subjected to an aging step. The aging step includes an ice bath and stirring hard. The ice bath is conducted at 5° C. or a lower temperature. The aging step last for 6 to 48 hours. After the aging step, the hydrolysis condensation is completed. Thus, there is provided a second solution, i.e., a clear metal sol-gel solution. The aging step is taken to enhance bonding together of particles of the xerogel.

At S150, the second solution is filled in a solvothermal device and heated to and remained at a reaction temperature of 230° C. to 400° C. for 2 to 6 hours. The density of the solvent is controlled to be close to but not higher than the critical density of the solvent. The density of the solvent of the second solution is lower than 0.272 g/cm³ for methanol or 0.276 g/cm³ for ethanol. In the operation temperature range, the pressure is higher than the critical pressure of the solvent such as 8.09 MPa for methanol and 6.14 MPa for ethanol. The critical density of the solvent is defined to be the density of the solvent at the critical point (the temperature is the critical temperature and the pressure is the critical pressure). Should the density of the solvent is higher than the critical density of the solvent and the temperature is higher than the critical temperature, there could be explosion because of rapid rising of the pressure.

At S160, the solvothermal device is cooled to the room temperature to provide a solution containing transparent conductive ITO powder.

At S170, the solution, which contains the transparent conductive ITO powder, is filtered and washed, thus providing nanometer crystalline ITO powder.

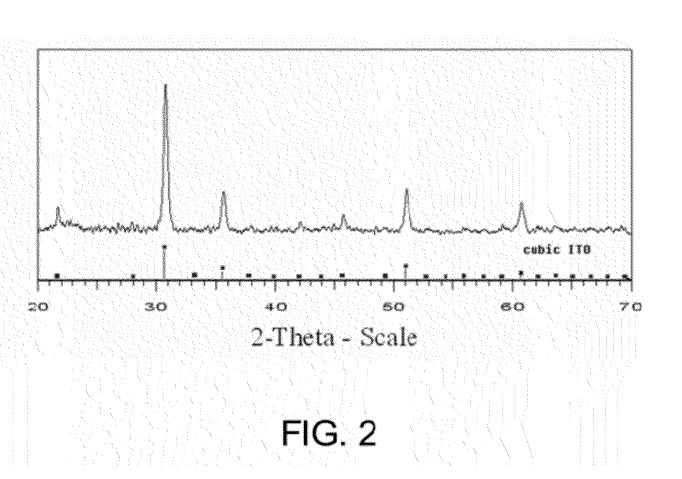

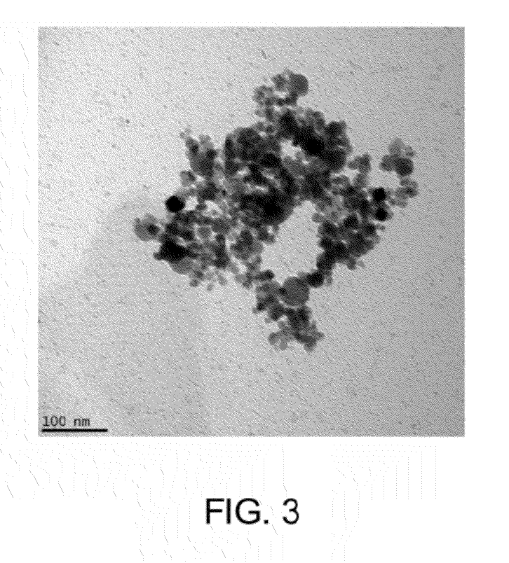

Referring to FIGS. 2 and 3, the ITO powder is observed in an X-ray diffraction (“XRD”) and a transmission electron microscope (“TEM”). A shown, the ITO powder is in the order of nanometer.

As discussed above, a sol-gel method is combined with a solvothermal method to provide the ITO powder according to the present invention. By controlling the conditions of the solution of the precursor and the solvothermal parameters, the synthesis and scattering are completed in the solvothermal phase. The ratio of the components of the ITO powder and the evenness of the ITO powder are controlled. Thus, the quality of the ITO powder is increased, and so is the quality of a transparent conductive oxide coating or a film made of the ITO powder.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for making nanometer ITO powder including the steps of:
adding first and second reactants to a solvent selected from the group consisting of alcohols and organic solvents to provide a clear metal ion solution;
adding the clear metal ion solution to a hydrolysis concentration solution containing water and a sour catalyst at a desired ratio to provide a first solution;
executing an aging step on the first solution and the hydrolysis concentration solution to provide a second solution; and
executing a solvothermal step on the second solution to provide multi-ingredient transparent conductive ITO powder in the order of nanometer, wherein the solvothermal step includes the steps of locating the second solution in a solvothermal device and heating the second solution to a solvothermal temperature for a solvothermal reaction.

2. The method according to claim 1, wherein the first and second reactants are selected from the group consisting of metal salts and metal mellow oxides.

3. The method according to claim 2, wherein the first reactant is a salt of indium.

4. The method according to claim 2, wherein the second reactant is a salt of tin.

5. The method according to claim 1, wherein the solvent is selected from the group consisting of methanol and ethanol.

6. The method according to claim 1, wherein the organic solvent is selected from the group consisting of ethylene golycol and ethylene diamine.

7. The method according to claim 1, wherein the sour catalyst is HNO₃.

8. The method according to claim 1, wherein the aging step lasts for 6 to 48 hours.

9. The method according to claim 1, wherein the aging step is executed at about 5° C.

10. The method according to claim 1, wherein the density of the agent of the second solution is smaller than the critical density of the same, wherein the solvothermal step is executed at a pressure lower than the critical pressure of the agent of the second solution.

11. The method according to claim 1, wherein the solvothermal temperature is 250° C. to 400° C.

12. The method according to claim 1, wherein the heating lasts for 2 to 6 hours.
